(19) United States
(12) Patent Application Publication
(10) Pub. No.: US 2011/0109764 A1
(43) Pub. Date: May 12, 2011

(54) AUTOFOCUS TECHNIQUE UTILIZING GRADIENT HISTOGRAM DISTRIBUTION CHARACTERISTICS

(76) Inventor: Li Hong, San Diego, CA (US)

(21) Appl. No.: 13/001,768

(22) PCT Filed: Sep. 24, 2008
(86) PCT No.: PCT/US08/77574

§ 371 Date: Dec. 28, 2010

(51) Int. Cl. H04N 5/225; G06K 9/00

(52) U.S. Cl. 348/222.1; 382/170; 348/E05.024

(57) ABSTRACT

A method for estimating if an optical assembly (238) is focused on a scene (12) includes the steps of: capturing information for an image (14) of the scene (12); determining an image gradient histogram distribution (360) of at least a portion of the image (14); determining a Gaussian model gradient histogram distribution (361) of the image (14); and comparing at least a portion of the image gradient histogram distribution (360) to the Gaussian model gradient histogram distribution (361) of the image (14) to estimate if the image (14) is properly focused.

### BACKGROUND

Cameras are commonly used to capture an image of a scene that includes one or more objects. Many cameras include a capturing system, a optical assembly, and an auto-focusing (“AF”) feature that automatically adjusts the focus of the optical assembly until one or more of the objects from the scene are optimally focused on the capturing system. In most AF techniques, a focus measure is defined to check the focus degree (or in another word, sharpness degree). Ideally, the focus measure should be a unimodal function that reaches maximum for the best-focused image and generally decreases as the focus decreases. Thus, the AF problem is essentially a search of a maximum focus measure in the lens position space. Accordingly, the definition of focus measure is crucial to the success of the AF technique.

Unfortunately, because the focus measure that is used in existing AF methods is too sensitive to noise and aliasing, existing AF methods do not necessarily lead to optimal results. Stated in another fashion, although various different focus measuring methods have been utilized successfully in cameras, AF still remains as an active research area for further improvement.

### SUMMARY

The present invention is directed to a method for estimating if a optical assembly is properly focused on a scene. In one embodiment, the method includes the steps of: capturing information for an image of the scene; determining an image gradient histogram distribution of at least a portion of the image; determining a Gaussian model gradient histogram distribution for the image; and comparing at least a portion of the image gradient histogram distribution to the Gaussian model gradient histogram distribution of the image to estimate if the image is in focus.

One idea behind this method is that sharp images have a heavy-tailed distribution in the image gradient histogram distribution. Stated in another fashion, sharp images show significantly more probability to large image gradient histogram distribution than the Gaussian model gradient histogram distribution. In one embodiment, the present invention defines the focus measure as the difference of large gradients distribution probability between a given image and the Gaussian model. With the present invention, the focus measure will show larger positive value for a properly focused sharp image and a smaller value for defocused, blurred image. Further, because the focus measure is the difference in large gradient distribution, the focus measure is less sensitive to noise because individual pixel values have less influence on the focus measure. Thus, a pixel with large gradient will have only a small influence on the focus measure provided herein. Moreover, the present method measures gradient distribution and is less influenced by the exact gradient values of the pixels. Thus, a noisy pixel will have less influence on the focus measure.

As provided herein, the step of capturing information can include the step of capturing information for a plurality of alternative images of the scene. In this embodiment, the step of determining an image gradient histogram distribution can include the step of determining an image gradient histogram distribution for at least a portion of each of the plurality of alternative images. Further, the step of comparing includes the step of comparing at least a portion of the image gradient histogram distribution for each of the alternative images to the Gaussian model gradient histogram distribution to estimate which of the alternative images is in focus. Additionally, the step of comparing can include the step of selecting the image having the greatest number of large gradients as being in focus.

In another embodiment, the step of comparing can include the step of comparing an image tail section of the image gradient histogram distribution with a Gaussian tail section of the Gaussian model gradient histogram distribution. In this embodiment, the image is in focus if the image tail section is much greater than the Gaussian tail section. In yet another embodiment, the method includes the steps of: capturing a plurality of images of the scene, each image being captured with the optical assembly at a different adjustment; and determining an image gradient histogram distribution for each of images. This embodiment can include the step of comparing at least a portion of the image gradient histogram distribution for each of the images to each other to estimate which image is best focused.

Further, the step of comparing can include the step of selecting the image having the greatest number of large gradients as being in focus. Further, the step of comparing can include the step of comparing an image tail section of each image gradient histogram distribution. Moreover, the image which includes the largest tail section can be selected as being in focus.

The present invention is also directed to an image apparatus for capturing an image of a scene. As provided herein, the image apparatus can utilize one or more of the methods disclosed herein to focus a optical assembly of the image apparatus.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified view of a scene, an image apparatus having features of the present invention, a sharp first image, a slightly blurred second image, and a really blurred third image;

FIG. 2 is a simplified front perspective view of the image apparatus of FIG. 1;

FIG. 3A is a graph that illustrates an absolute value for an image gradient histogram distribution for the first image, and a Gaussian model gradient histogram distribution for the first image;

FIG. 3B is a graph that illustrates an absolute value for an image gradient histogram distribution for the second image, and a Gaussian model gradient histogram distribution for the second image;

FIG. 3C is a graph that illustrates an absolute value for an image gradient histogram distribution for the third image, and a Gaussian model gradient histogram distribution for the third image;

FIG. 4A is a graph that illustrates an absolute value for an image gradient histogram distribution for a plurality of alternative images;

FIG. 4B is a graph that illustrates an absolute value of a tail section for the plurality of alternative images of FIG. 4A;

FIG. 5 is a flow chart that further illustrates a first method of auto-focusing having features of the present invention; and

FIG. 6 is a flow chart that further illustrates a second method of auto-focusing having features of the present invention.

### DESCRIPTION

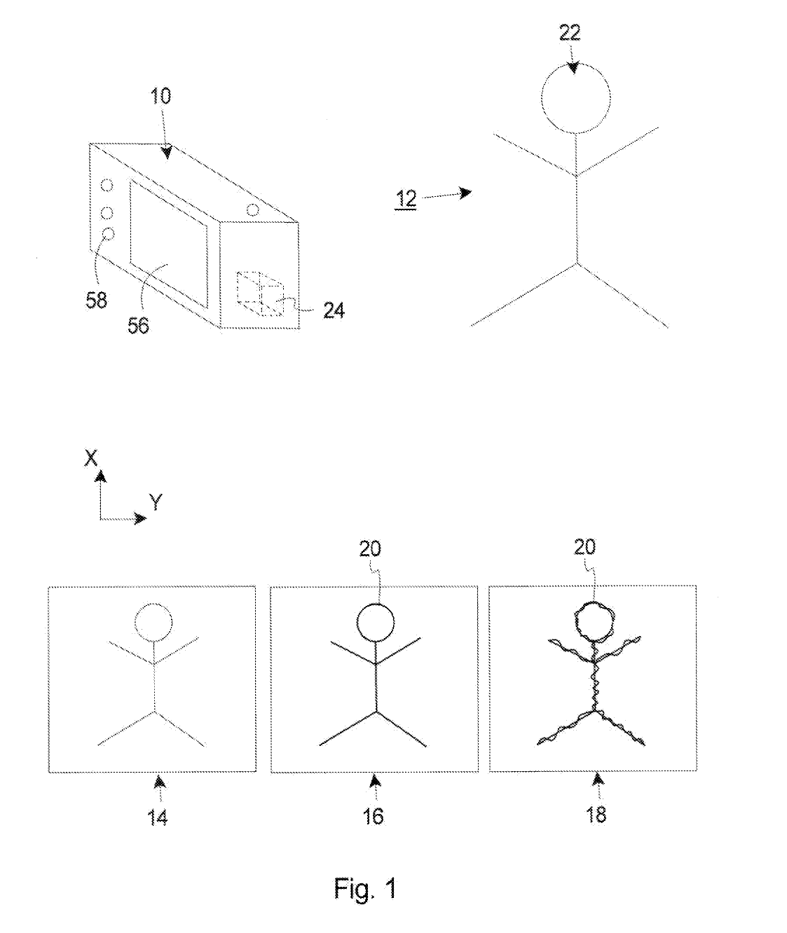

FIG. 1 is a simplified perspective illustration of an image apparatus 10 having features of the present invention, and a scene 12. The image apparatus 10 captures first information for a raw first captured image 14 (illustrated away from the image apparatus 10), second information for a raw second captured image 16 (illustrated away from the image apparatus), and third information for a raw third captured image 18 (illustrated away from the image apparatus). In FIG. 1, the first captured image 14 is a sharp image because the image apparatus 10 was properly focused when the first information was captured, the second captured image 16 is slightly blurred 20 (illustrated as a thicker line) because the image apparatus 10 was not properly focused when the second information was captured, and the third captured image 18 is really blurred 20 (illustrated as a wavy line) because the image apparatus 10 was really improperly focused when the third information was captured.

In one embodiment, the image apparatus 10 includes a control system 24 (illustrated in phantom) that uses a unique method for estimating when the image apparatus 10 is properly focused on the scene 12. Stated in another fashion, the control system 24 performs an auto focusing technique that utilizes a new focus measuring method. More specifically, the new focus measuring method is based on an image gradient histogram distribution for the particular image being evaluated. This focus measuring method can be less sensitive to noise. As a result thereof, the control system 24 can be used to accurately focus the image apparatus 10 so that the desired captured image is sharp.

As provided herein, one or more of the captured images 14, 16, 18 can be thru images that are captured during focusing of the image apparatus 10, prior to capturing the desired image. As an overview, in one embodiment, the control system 24 calculates an image gradient histogram distribution for one or more of the captured images 14, 16, 18 during the auto-focusing procedure. These image gradient histogram distributions can be compared to each other and/or a Gaussian model gradient histogram distribution during the auto-focusing procedure to determine when the image apparatus 10 is properly focused.

The type of scene 12 captured by the image apparatus 10 can vary. For example, the scene 12 can include one or more objects 22, e.g. animals, plants, mammals, and/or environments. For simplicity, in FIG. 1, the scene 12 is illustrated as including one object 22. Alternatively, the scene 12 can include more than one object 22. In FIG. 1, the object 22 is a simplified stick figure of a person.

FIG. 1 also includes an orientation system that illustrates an X axis, and a Y axis that is orthogonal to the X axis. It should be noted that these axes can also be referred to as the first and second axes.

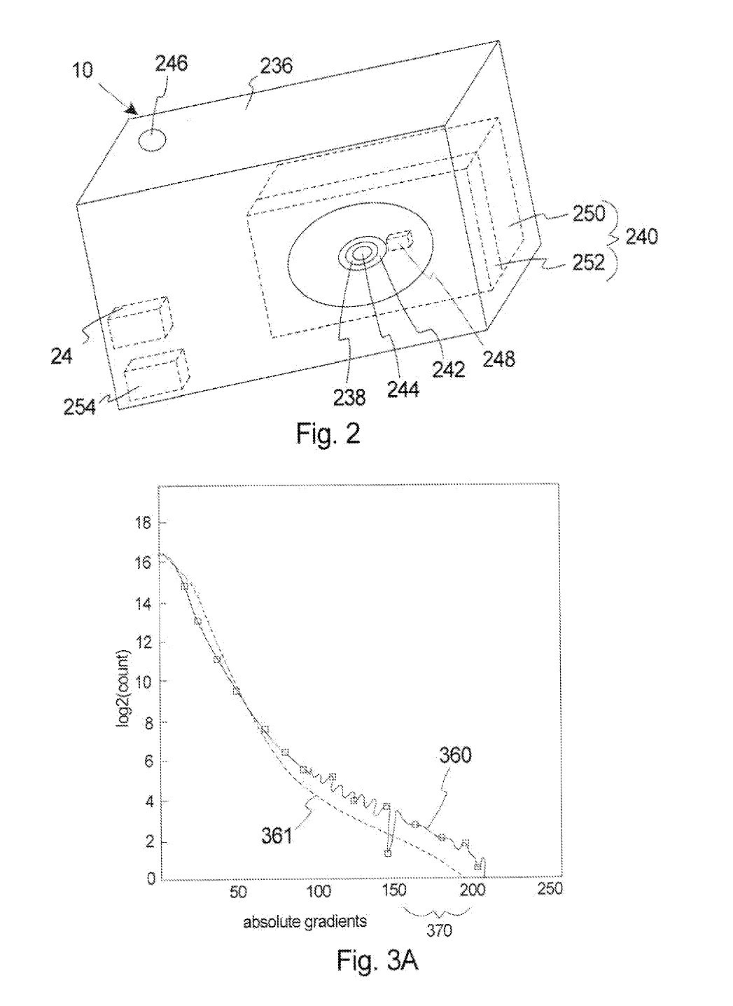

FIG. 2 illustrates a simplified, front perspective view of one, non-exclusive embodiment of the image apparatus 10. In this embodiment, the image apparatus 10 is a digital camera, and includes an apparatus frame 236, an optical assembly 238, and a capturing system 240 (illustrated as a box in phantom), in addition to the control system 24 (illustrated as a box in phantom). The design of these components can be varied to suit the design requirements and type of image apparatus 10. Further, the image apparatus 10 could be designed without one or more of these components. Additionally or alternatively, the image apparatus 10 can be designed to capture a video of the scene 12.

The apparatus frame 236 can be rigid and support at least some of the other components of the image apparatus 10. In one embodiment, the apparatus frame 236 includes a generally rectangular shaped hollow body that forms a cavity that receives and retains at least some of the other components of the camera.

The apparatus frame 236 can include an aperture 242 and a shutter mechanism 244 that work together to control the amount of light that reaches the capturing system 240. The shutter mechanism 244 can be activated by a shutter button 246. The shutter mechanism 244 can include a pair of blinds (sometimes referred to as “blades”) that work in conjunction with each other to allow the light to be focused on the capturing system 240 for a certain amount of time. Alternatively, for example, the shutter mechanism 244 can be all electronic and contain no moving parts. For example, an electronic capturing system 240 can have a capture time controlled electronically to emulate the functionality of the blinds.

The optical assembly 238 can include a single lens or a combination of lenses that work in conjunction with each other to focus light onto the capturing system 240. In one embodiment, the image apparatus 10 includes an autofocus assembly 248 (illustrated as a block in phantom) including one or more lens movers that adjust one or more lenses of the optical assembly 238 until the sharpest possible image of the subject is received by the capturing system 240. The autofocus assembly 248 is described in more detail below.

It should be noted that each of the images 14, 16, 18 (illustrated in FIG. 1) were captured with a different focus of optical assembly 238.

The capturing system 240 captures information for the images 14, 16 (illustrated in FIG. 1). The design of the capturing system 240 can vary according to the type of image apparatus 10. For a digital type camera, the capturing system 240 includes an image sensor 250 (illustrated in phantom), a filter assembly 252 (illustrated in phantom), and a storage system 254 (illustrated in phantom).

The image sensor 250 receives the light that passes through the aperture 242 and converts the light into electricity. One non-exclusive example of an image sensor 250 for digital cameras is known as a charge coupled device (“CCD”). An alternative image sensor 250 that may be employed in digital cameras uses complementary metal oxide semiconductor (“CMOS”) technology.

The image sensor 250, by itself, produces a grayscale image as it only keeps track of the total quantity of the light that strikes the surface of the image sensor 250. Accordingly, in order to produce a full color image, the filter assembly 252 is generally used to capture the colors of the image.

The storage system 254 stores one or more of the finally captured images before these images are ultimately printed out, deleted, transferred or downloaded to an auxiliary storage system or a printer. The storage system 254 can be fixedly or removable coupled to the apparatus frame 236. Non-exclusive examples of suitable storage systems 254 include flash memory, a floppy disk, a hard disk, or a writeable CD or DVD.

The control system 24 is electrically connected to and controls the operation of the electrical components of the image apparatus 10. The control system 24 can include one or more processors and circuits, and the control system 24 can be programmed to perform one or more of the functions described herein. In FIG. 2, the control system 24 is secured to the apparatus frame 236 and the rest of the components of the image apparatus 10. Further, the control system 24 is positioned within the apparatus frame 236.

In certain embodiments, the control system 24 includes auto-focusing software that evaluates whether the optical assembly 238 is optimally focused prior to capturing the final image and controls the focusing of the optical assembly 238.

Referring back to FIG. 1, the image apparatus 10 can include an image display 56 that displays the finally captured image. With this design, the user can decide which images should be stored and which images should be deleted. In FIG. 1, the image display 56 is fixedly mounted to the rest of the image apparatus 10. Alternatively, the image display 56 can be secured with a hinge mounting system (not shown) that enables the display 56 to be pivoted. One non-exclusive example of an image display 56 includes an LCD screen.

Further, the image display 56 can display other information that can be used to control the functions of the image apparatus 10.

Moreover, the image apparatus 10 can include one or more control switches 58 electrically connected to the control system 24 that allows the user to control the functions of the image apparatus 10. For example, one or more of the control switches 58 can be used to selectively switch the image apparatus 10 to the auto-focusing processes disclosed herein.

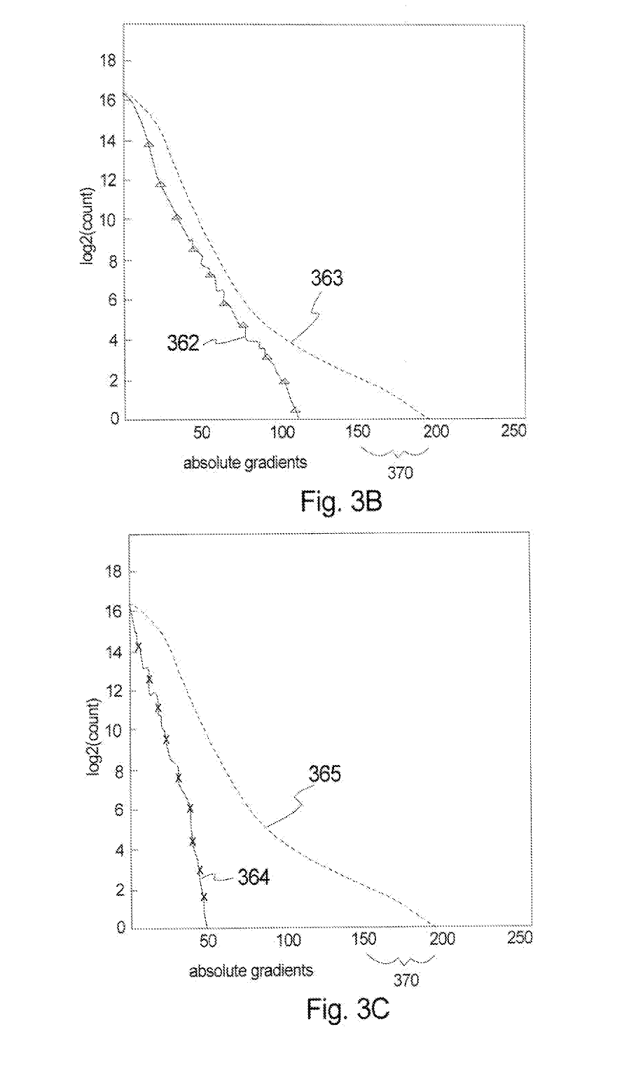

FIG. 3A is a graph that illustrates an absolute value for a first image gradient histogram distribution 360 (illustrated as a line with squares) for the first image 14 (illustrated in FIG. 1), and an absolute value for a Gaussian model gradient histogram distribution 362 (illustrated as a dashed line) for the first image 14; FIG. 3B is a graph that illustrates an absolute value for a second image gradient histogram distribution 362 (illustrated as a line with triangles) for the second image 16 (illustrated in FIG. 1), and an absolute value for a Gaussian model gradient histogram distribution 363 (illustrated as a dashed line) for the second image 16; and FIG. 3C is a graph that illustrates an absolute value for a third image gradient histogram distribution 364 (illustrated as a line with X′s) for the third image 18 (illustrated in FIG. 1), and an absolute value for a Gaussian model gradient histogram distribution 365 (illustrated as a dashed line) for the third image 18.

In FIGS. 3A-3C, the vertical axis represents the count value (e.g. the number of pixels with a specific gradient value), while the horizontal axis represents the gradient value. Thus, the higher the count value vertically represents a higher number of pixels that have that gradient value, while the gradient value increases moving left to right in FIG. 1

It should be noted that the typical gradient histogram distribution would have the shape of a bell curve. However, because only the absolute value is illustrated in FIGS. 3A-3C, the gradient histogram distributions 360, 361, 362, 363 364, 365 have the shape of one half of a bell curve.

For each image 14, 16, 18, the respective image gradient histogram distribution 360, 362, 364 represents how much difference exists between each pixel and its neighboring pixels in the respective image. The difference can be measured along the X axis, along the Y axis, diagonally, or along some other axis. Further, the difference can be the intensity difference, the contrast difference, or some other difference.

For example, for the first image 14, the absolute value for the first image gradient histogram distribution 360 can represent how much difference in intensity exists between adjacent pixels along the X axis. This example can be represented as following equation:

Gx=|G(i,j)−G(i+1,j)|

where G(i,j) represents the intensity of a pixel located at i, j; and G(i+1, j) represents the intensity of a pixel located at i+1, j.

Alternatively, for the first image 14, the absolute value for the first image gradient histogram distribution 360 can represent how much difference in intensity exists between adjacent pixels along the Y axis. This example can be represented as following equation:

Gy=|G(i,j)−G(i,j+1)|

where G(i,j) represents the intensity of a pixel located at i, j; and G(i,j+1) represents the intensity of a pixel located at i, j+1.

The second image gradient histogram distribution 362, and the third image gradient histogram distribution 364 can be calculated in a similar fashion.

It should be noted that the respective image gradient histogram distribution 360, 362, 364 can be calculated for the entire respective image 14, 16, 18. Alternatively, the respective image gradient histogram distribution 360, 362, 364 can be calculated for just a selected region of the respective image 14, 16, 18. For example, a respective image gradient histogram distribution 360, 362, 364 can be calculated for just a centrally located square region of the respective image 14, 16, 18.

The Gaussian model is an adaptive reference model that is based on the image gradient histogram curve. In one embodiment, the Gaussian model is computed from a standard Gaussian function with variation 2.5 and window size of 150. The scale of the Gaussian model is computed as the ratio of the sum of the image gradient histogram to the sum of the standard Gaussian function. In certain embodiments, the Gaussian model window width is within approximately 120-180 gradients. Typically, the higher the peak distribution value, the smaller the Gaussian window width. Further, the higher the number of large image gradients, the bigger the Gaussian window width.

Stated in another fashion, the reference Gaussian model can be adjusted based on the image gradient characteristics. In general, the Gaussian model window size is approximately 150, with the large gradient cutoff of approximately 100-150. The Gaussian model scale is ratio from the area of the gradient curve to the area of the Gaussian model. In certain embodiments, the model is adaptively adjusted based on the image gradient histogram characteristics. In one embodiment, the basic adjusting rule includes (i) increasing or decreasing the window size based on the amount of high gradients present in the image, (ii) adjusting the cut-off window size based on the adjusted Gaussian window, and (iii) constraining the Gaussian model scale in certain range (not too low and not too high).

Comparing each image gradient histogram distribution 360, 362, 364 with its respective Gaussian model gradient histogram distribution 361, 363, 365 illustrates that the first image gradient histogram distribution 360 for a sharp image 14 has significantly more probability to large gradients than the Gaussian model gradient histogram distribution 361, while the second and third gradient histogram distributions 362, 364 for blurry images 16, 18 has significantly less probability for large gradients than their respective Gaussian model gradient histogram distributions 363, 365. Thus, in certain embodiments, the present invention relies on the determination that a sharp image 14 will have significantly more probability to large gradients than the Gaussian model gradient histogram distribution 361.

Stated in another fashion, sharp images 14 have a heavy-tailed distribution in their image gradient histogram distribution 360. Further, the sharp image gradient histogram distributions 360 show significantly more probability to large gradients than the Gaussian model gradient histogram distribution 361. In this embodiment, the present invention defines the focus measure as the difference of large gradients distribution probability between a given image and the Gaussian model. With the present invention, the focus measure will show larger positive value for a focused thru image and a smaller value for defocused thru image.

As provided herein, the present invention can focus on a tail section 370 of the gradient distribution to determine if an image is in focus. As used herein the term “tail section” 370 shall refer to the last portion of the gradient histogram, i.e. the last 10-20 percent of the respective Gaussian model gradient histogram distribution 361, 363, 365. Because the Gaussian model varies according to the scene, the exact value for the tail section 370 will vary according to the scene that is being captured. In the examples illustrated in FIGS. 3A-3C, the Gaussian model gradient histogram distribution 361, 363, 365 has a maximum value of approximately 200. In this example, the tail section 370 can have a value of greater than approximately 160 and above (e.g. last 20% of Gaussian model gradient histogram distribution).

In this embodiment, reviewing the tail section 370 area of graphs in FIG. 3A-3C, only the first image gradient histogram distribution 360 has a larger tail section 370 than the Gaussian model gradient histogram distribution 361. Further, the second and third image gradient histogram distributions 362, 364 do not even extend to the tail section 370. Thus, only the first image 14 is in focus, while the second and third images 16, 18 are not in focus.

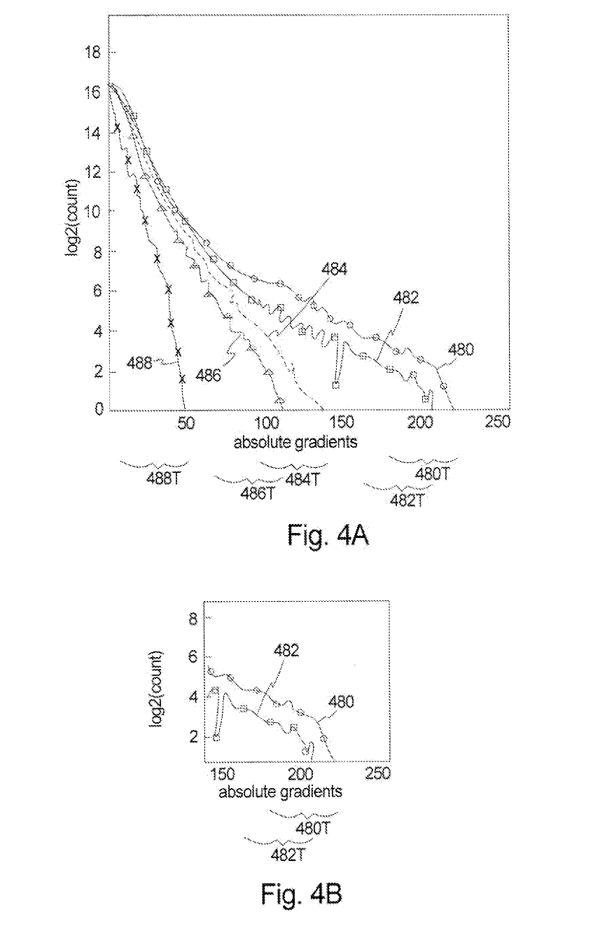

Referring to FIGS. 4A and 4B, in another embodiment, the present invention selects the image gradient histogram distribution having the largest tail distribution as the image that is in focus. FIG. 4A is a graph that illustrates an absolute value for a plurality of image gradient histogram distributions 480, 482, 484, 486, 488 for a plurality of alternative images; and FIG. 4B is a graph that illustrates an absolute value of a plurality of tail sections 480T, 482T for the plurality of alternative image gradient histogram distributions 480, 482 of FIG. 4A. It should be noted that only two of the tail sections 480T, 482T are illustrated in FIG. 4B because the other tail sections 484T, 486T, 488T are too short.

In this embodiment, during the auto-focusing procedure, the control system 24 (not shown in FIGS. 4A and 4B) adjusts the optical assembly 238 (not shown in FIGS. 4A and 4B) to a plurality of alternative adjustments while causing the capturing system 240 (not shown in FIGS. 4A and 4B) to capture the alternative thru images. Subsequently, the image gradient histogram distributions 480, 482, 484, 486, 488 are generated by the control system 24. Next, the control system 24 compares the image gradient histogram distributions 480, 482, 484, 486, 488 to select the image with the best image gradient histogram distributions 480, 482, 484, 486, 488 as being in focus.

Somewhat similar to the method described above, the present invention defines the focus measure as the difference of large gradients distribution probability between a thru images. Again, in this embodiment, the focus measure will show larger positive value for a focused thru image and a smaller value for defocused thru image.

In the embodiment illustrated in FIG. 4A, the image gradient histogram distribution 480 has the best large gradient distribution. Thus, the optical assembly 238 position used during capturing of the image that resulted in image gradient histogram distribution 480 will be used for capturing the final image. As described above, FIG. 4B illustrates the image tail sections 480T, 482T for a couple of the image gradient histogram distributions 480, 482. In one embodiment, the image tail sections 480T, 482T, 484T, 486T, 488T shall refer to the last portion (i.e. last 10-20 percent) of the respective image gradient histogram distributions 480, 482, 484, 486, 488. Because the image gradient histogram distributions 480, 482, 484, 486, 488 vary according to the scene, the exact value for the image tail sections 480T, 482T, 484T, 486T, 488T will vary according to the scene that is being captured.

In this embodiment, the image tail sections 480T, 482T, 484T, 486T, 488T are compared and the image tail sections 480T, 482T, 484T, 486T, 488T with the most large gradients is selected as the thru image that is in focus.

It should be noted that the methods disclosed herein can be used separately or in conjunction with other auto-focusing techniques to improve the accuracy of the auto-focusing techniques. If used in conjunction, the proposed focus measure can be used as a coarse blur degree estimation of the image at the selecting lens position.

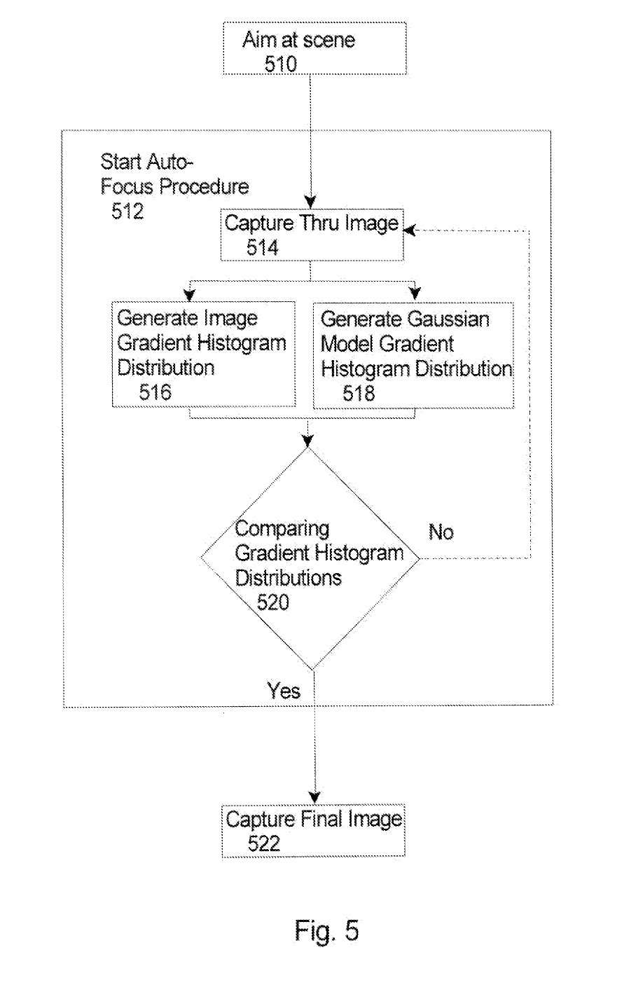

FIG. 5 is a simplified flow chart that illustrates a first, non-exclusive method of auto-focusing. It should be noted that one or more of the steps can be omitted or the order of steps can be switched. First, the image apparatus is aimed toward the scene 510. Subsequently, the user presses lightly on the shutter button to start the auto-focusing process 512. This process can include capturing a thru image 514, generating an image gradient histogram distribution 516, generating a Gaussian Model gradient histogram distribution 518, comparing the image gradient histogram distributions 520. If the tail section of the image gradient histogram distribution is greater than the tail section of the Gaussian Model gradient histogram distribution this image can be estimated as being in focus. Alternatively, if the tail section of the image gradient histogram distribution is less than the tail section of the Gaussian Model gradient histogram distribution this image is not in focus and the control system adjusts the optical assembly and repeats steps 514 through 520 until it is satisfied.

Subsequently, after determining which thru image is in focus, the control system can adjust the optical assembly to the adjustment used for capturing that image, and the information for the final image can be captured 522.

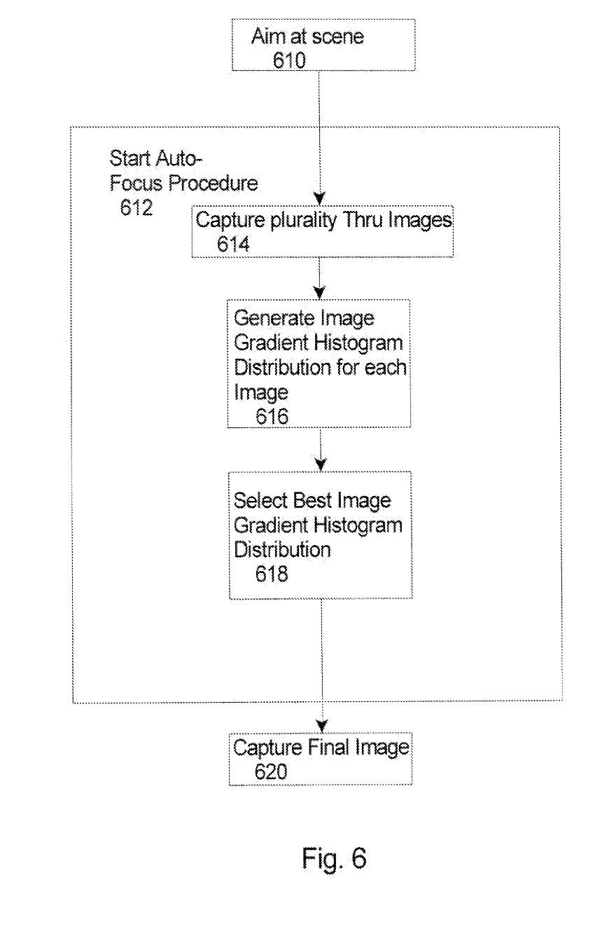

FIG. 6 is a flow chart that illustrates a second method of auto-focusing having features of the present invention. It should be noted that one or more of the steps can be omitted or the order of steps can be switched. First, the image apparatus is aimed toward the scene 610. Subsequently, the user presses lightly on the shutter button to start the auto-focusing process 612. This process can include capturing a plurality of thru images with each thru image being captured at a different adjustment of the optical assembly 614. Next, an image gradient histogram distribution is generated for each of the thru images 616. Subsequently, the control system selects the image gradient histogram distribution with the best tail section 618.

Subsequently, after determining which thru image is in focus, the control system can adjust the optical assembly to the adjustment used for capturing that image, and the information for the final image can be captured 620.

While the current invention is disclosed in detail herein, it is to be understood that it is merely illustrative of the presently preferred embodiments of the invention and that no limitations are intended to the details of construction or design herein shown other than as described in the appended claims.

What is claimed is:

1. A method for estimating if an optical assembly is focused on a scene, the method comprising the steps of:
capturing information for an image of the scene;
determining an image gradient histogram distribution of at least a portion of the image;
determining a Gaussian model gradient histogram distribution of at least a portion of the image; and
comparing at least a portion of the image gradient histogram distribution to the Gaussian model gradient histogram distribution of the image to estimate if the image is in focus.

2. The method of claim 1 wherein the step of capturing information includes the step of capturing information for a plurality of alternative images from the scene, wherein the step of determining an image gradient histogram distribution includes the step of determining an image gradient histogram distribution for at least a portion of each of the plurality of alternative images, and wherein the step of comparing includes the step of comparing at least a portion of the image gradient histogram distribution for each of the alternative images to a Gaussian model gradient histogram distribution of each image to estimate which of the alternative images is in focus.

3. The method of claim 2 wherein the step of comparing includes the step of selecting the image having the greatest number of large gradients as being in focus.

4. The method of claim 1 wherein the step of comparing includes the step of comparing an image tail section of the image gradient histogram distribution with a Gaussian tail section of the Gaussian model gradient histogram distribution.

5. The method of claim 4 wherein the image is in focus if the image tail section is greater than the Gaussian tail section.

6. The method of claim 5 wherein the image is in not in focus if the image tail section is less than the Gaussian tail section.

7. A method for estimating when an optical assembly is focused on a scene, the method comprising the steps of:
capturing a plurality of images of the scene, each image being captured with the optical assembly at a different adjustment; and
determining an image gradient histogram distribution for each of images.

8. The method of claim 7 further comprising the step of comparing at least a portion of the image gradient histogram distribution for each of the images to each other to estimate which image is best focused.

9. The method of claim 7 wherein the step of comparing includes the step of selecting the image having the greatest number of large gradients as being in focus.

10. The method of claim 7 wherein the step of comparing includes the step of comparing an image tail section of each image gradient histogram distribution.

11. The method of claim 10 wherein the image which includes the largest tail section is selected as being in focus.

12. An image apparatus for capturing an image of a scene, the image apparatus comprising:
a capturing system for capturing information for a thru image of the scene;
a control system that (i) determines an image gradient histogram distribution of at least a portion of the thru image, (ii) determines a Gaussian model gradient histogram distribution of the thru image, and (iii) compares at least a portion of the image gradient histogram distribution to the Gaussian model gradient histogram distribution of the thru image to estimate if the thru image is in focus.

13. The image apparatus of claim 12 wherein the capturing system captures information for a plurality of alternative thru images from the scene with an optical assembly alternative adjustments, and wherein the control system (i) determines an image gradient histogram distribution for at least a portion of each of the plurality of alternative thru images, and (ii) compares at least a portion of the image gradient histogram distribution for each of the alternative images to the Gaussian model gradient histogram distribution to estimate which of the alternative thru images is in focus.

14. The image apparatus of claim 13 wherein the control system selects the thru image having the greatest number of large gradients as being in focus.

15. The image apparatus of claim 12 wherein the control system compares an image tail section of the image gradient histogram distribution with a Gaussian tail section of the Gaussian model gradient histogram distribution.

16. The image apparatus of claim 15 wherein the thru image is in focus if the image tail section is greater than the Gaussian tail section.

17. The image apparatus of claim 16 wherein the thru image is in not in focus if the image tail section is less than the Gaussian tail section.

18. An image apparatus for capturing an image of a scene, the image apparatus comprising:
an optical assembly;
a capturing system for capturing information for a plurality of thru images of the scene with each thru image being captured while the optical assembly is at a different adjustment; and
a control system that determines an image gradient histogram distribution for each of the thru image.

19. The image apparatus of claim 18 wherein the control system compares at least a portion of the image gradient histogram distribution for each of the images to each other to estimate which image is best focused.

20. The image apparatus of claim 18 wherein the control system selects the image having the greatest number of large gradients as being in focus.

21. The image apparatus of claim 18 wherein the control system compares an image tail section of each image gradient histogram distribution.

22. The image apparatus of claim 21 wherein the control system selects the thru image which includes the largest tail section is selected as being in focus.
